(19) United States
(12) Patent Application Publication
(10) Pub. No.: US 2014/0365547 A1
(43) Pub. Date: Dec. 11, 2014

(54) MIXED-RADIX PIPELINED FFT PROCESSOR AND FFT PROCESSING METHOD USING THE SAME

(71) Applicant: Electronics and Telecommunications Research Institute, Daejeon (KR)

(72) Inventors: Jin-Kyu KIM, Sejong (KR); Bon-Tae KOO, Daejeon (KR)

(73) Assignee: Electronics and Telecommunications Research Institute, Daejeon (KR)

(21) Appl. No.: 14/138,419

(22) Filed: Dec. 23, 2013

(30) Foreign Application Priority Data
Jun. 5, 2013 (KR) 10-2013-0064692

(51) Int. Cl. G06F 17/14

(52) U.S. Cl. CPC G06F 17/142
USPC 708/404

(57) ABSTRACT

Disclosed herein are a mixed-radix pipelined Fast Fourier Transform (FFT) processor and an FFT processing method using the same. The mixed-radix pipelined Fast Fourier Transform (FFT) processor includes a first radix chain, a second radix chain, an input buffer, and an output buffer. The first radix chain includes first radix processors that are connected in series to each other. The second radix chain includes second radix processors that are connected in series to each other, and is connected in series to the first radix chain. The input buffer performs index mapping on a sequence input to the first radix chain. The output buffer generates a final FFT output by performing index mapping on a sequence generated using outputs of one or more of the first and second radix chains.

### CROSS REFERENCE TO RELATED APPLICATION

This application claims the benefit of Korean Patent Application No. 10-2013-0064692, filed on Jun. 5, 2013, which is hereby incorporated by reference in its entirety into this application.

### BACKGROUND OF THE INVENTION

1. Technical Field

The present invention relates generally to a Fast Fourier Transform (FFT) processor and, more particularly, to an FFT apparatus that is being widely used for Orthogonal Frequency Division Multiplexing (OFDM) and Single-Carrier Frequency Division Multiplexing (SC-FDM).

2. Description of the Related Art

Recently, Long Term Evolution (LTE) systems are being widely used to meet the demand for high-speed and high-capacity transmission as a fourth generation communication method. An LTE system is divided into an LTE downlink system that transmits data from a base station to a terminal and an LTE uplink system that transmits data from a terminal to a base station.

The LTE downlink system uses OFDM, while the LTE uplink system uses SC-FDM that has a Peak-to-Average Ratio (PAR) characteristic suitable for low power operation.

The OFDM uplink system and the SC-FDM downlink system require FFT processors that are capable of high-speed data processing in order to perform baseband signal processing. In particular, the SC-FDM downlink system requires not only FFT lengths of powers of 2 but also a mixed-radix FFT processor based on prime numbers, such as 2, 3 and 5.

Conventional FFT processors are classified into two types.

A first type of FFT processor has a structure that includes a radix-r processor and single memory of an N-word size, that is, an FFT length. When single memory is used, an in-place algorithm should be used. In the in-place scheme, single memory having an address size corresponding to the length of an FFT is given, data is read from a specific address of the memory, a radix-r operation is performed, and then the results of the operation are stored back in memory space of the same address. This type of FFT processor has the disadvantage of low throughput because a single radix-r operation unit is used, and thus the overall operation time is increased by a value corresponding to the length of the FFT and the number of stages. In contrast, this type of FFT processor is advantageous in that the use of the single radix-r operation unit is beneficial in terms of circuit size, hardware cost is low, and low power implementation can be easily achieved. This type of FFT processor is suitable for the field of application that requires narrow bandwidth and low throughput, such as a Digital Audio Broadcasting (DAB) system.

A second type of FFT processor has a pipelined structure in which multiple radix-r processors are arranged and buffers are interposed between the radix-r processors. In the pipelined FFT structure, the entire structure includes multiple stages and the stages are connected in series to each other. Each of the stages has a unique radix-r processor and a separate buffer configured to store data. Accordingly, independent operations can be performed, and thus multiple radix-r operations can be performed at the same time. As a result, the pipelined FFT structure is the same as the in-place scheme in terms of the use of memory, and can achieve considerably higher throughput than the in-place scheme because radix-r operations can be performed at respective stages at the same time. However, the pipelining scheme has the disadvantage of large hardware size because it should maintain a plurality of radix-r processors, and is suitable for the fields of application, such as a Wireless LAN (WLAN) or LTE that requires high-speed processing.

In particular, upon processing prime length FFTs, an in-place type FFT processor is frequently used because of the complexity of control and implementation.

Korean Patent Application Publication No. 2012-0071297 discloses a configuration in which radix-2, radix-3 and radix-5 engines are separately provided and discrete Fourier transforms are performed through parallel processing. However, this configuration is problematic in that it has lower throughput than the pipelining scheme.

Furthermore, the paper “A Generalized Mixed-Radix Algorithm for Memory-Based FFT Processors” by Chen-Fong Hsiao et al. discloses a technology that increases data throughput using an FFT core configured to process radix-2, radix-3, and radix-5 processes, two memory modules composed of multiple banks, and a data exchange switch in the in-place scheme. However, this technology is problematic in that it has lower throughput than the pipelining scheme.

As a result, there is an urgent need for a new pipelined FFT processor that can be efficiently applied to the processing of prime length FFTs.

### SUMMARY OF THE INVENTION

Accordingly, the present invention has been made keeping in mind the above problems occurring in the conventional art, and an object of the present invention is to provide a pipelined FFT processor that can be efficiently applied to the processing of prime length FFTs, that is efficient in terms of a circuit area, and that has high throughput.

Another object of the present invention is to provide an FFT processor that includes radix-r chains corresponding to different prime numbers, and that is configured such that each of the radix-r chains operates in a pipelining manner.

Still another object of the present invention is to provide a pipelined FFT processor that includes radix-r chains corresponding to different prime numbers, that does not require twiddle factor Read Only Memory (ROM) because twiddle factor multiplications do not need to be performed between the chains, that does not require variable complex multiplications, and that can process 34 FFT lengths required by the LTE standard using only trivial multipliers.

In accordance with an aspect of the present invention, there is provided a mixed-radix pipelined FFT processor, including a first radix chain configured to include first radix processors that are connected in series to each other; a second radix chain configured to include second radix processors that are connected in series to each other, and to be connected in series to the first radix chain; an input buffer configured to perform index mapping on a sequence input to the first radix chain; and an output buffer configured to generate a final FFT output by performing index mapping on a sequence generated using the outputs of one or more of the first and second radix chains.

The first and second radices of the first and second radix chains may be all prime numbers.

The first and second radix chains may be directly connected to each other without twiddle factor multiplications.

The first radix chain may include first buffers configured to correspond to the first radix processors, first trivial multipliers configured to perform twiddle factor multiplications between the first radix processors, and a first multiplexer configured to multiplex the outputs of one or more of the first radix processors.

The second radix chain may include second buffers configured to correspond to the second radix processors, second trivial multipliers configured to perform twiddle factor multiplications between the second radix processors, and a second multiplexer configured to multiplex the outputs of one or more of the second radix processors.

The mixed-radix pipelined FFT processor may further include a third radix chain that includes third radix processors connected in series to each other and that is connected in series to the second radix chain; the third radix of the third radix change may be a prime number; the output buffer may generate the final FFT output by performing index mapping on a sequence generated using the outputs of one or more of the first, second and third radix chains; and the third radix chain may be connected in series to the second radix chain without twiddle factor multiplications.

The third radix chain may include third buffers configured to correspond to the third radix processors, one or more third trivial multipliers configured to perform twiddle factor multiplications between the third radix processors, and a third multiplexer configured to multiplex the outputs of one or more of the third radix processors.

The first, second and third radix chains may support various FFT lengths by controlling respective latencies corresponding to the first, second and third buffers.

In accordance with another aspect of the present invention, there is provided an FFT processing method, including performing pieces of radix processing using radix processors corresponding to a same radix; and generating an FFT output by performing a pipelining operation on two or more pieces of radix processing.

The radix processors may be connected in series to each other, and the radix is a prime number.

Performing the radix processing may include performing twiddle factor multiplications between the radix processors using trivial multipliers.

The pipelining operation may be performed without twiddle factor multiplications.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating a mixed-radix pipelined FFT processor according to an embodiment of the present invention;

FIG. 2 is a block diagram illustrating an example of the first radix chain illustrated in FIG. 1;

FIG. 3 is a block diagram illustrating an example of the second radix chain illustrated in FIG. 1;

FIG. 4 is a block diagram illustrating an example of the third radix chain illustrated in FIG. 1;

FIG. 5 is a diagram illustrating the radix and buffer configurations of 34 FFTs;

FIG. 6 is a flowchart illustrating an FFT processing method according to an embodiment of the present invention; and

FIG. 7 is a diagram illustrating the FFT latencies of the single memory-based FFT processor and the FFT processor of the present invention with respect to FFT lengths.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

Preferred embodiments of the present invention will be described in detail with reference to the accompanying drawings. In particular, a mixed-radix pipelined FFT processor and a processing method according to the present invention will be described using an FFT processor used for an LTE uplink as an example. First, a Discrete Fourier Transform (DFT) equation that is required by an LTE uplink will be described, an algorithm will be derived, and then a hardware structure suitable therefor will be presented.

First, a DFT function that is required by the LTE standard is represented by the following Equation 1:

$$X ( k ) = {\sum }_{n = 0}^{N - 1} x ( n ) {W}_{N}^{nk} \\ where \\ N = 12 m = {2}^{α} {3}^{β} {5}^{γ} , {W}_{N}^{nk} = {e}^{- j 2 π \frac{nk}{N}} \qquad ( 1 )$$

In Equation 1, W_{N} s a twiddle factor, n is a time index, and k is a frequency index. Furthermore, m is an integer in a range of 1 to 100, and α, β and γ are integers that are not negative. In order to reduce the complexity of computation, an N point DFT may be dissolved into N₂, N₃ and N₅ point FFTs. In this case, N₂, N₃ and N₅ have positive signs, and are integers of powers of 2, 3 and 5. In this case, if N₂, N₃ and N₅ are prime to one another, the following Equation 2 is satisfied:

$$\begin{matrix}n = ( {N}_{3} {N}_{5} {n}_{2} + {A}_{1} {N}_{5} {n}_{3} + {A}_{1} {B}_{1} {n}_{5} ) mod N \\ = ( {N}_{3} {N}_{5} {n}_{2} + {p}_{1} {N}_{2} {N}_{5} {n}_{3} + {p}_{1} {p}_{3} {N}_{2} {N}_{3} {n}_{5} ) mod N\end{matrix} \\ \begin{matrix}k = ( {A}_{2} {k}_{2} + {B}_{2} {N}_{2} {k}_{3} + {N}_{2} {N}_{3} {k}_{5} ) mod N \\ = ( {p}_{2} {N}_{3} {N}_{5} {k}_{2} + {p}_{4} {N}_{5} {N}_{2} {k}_{3} + {N}_{2} {N}_{3} {k}_{5} ) mod N\end{matrix} \\ where \{ \begin{matrix}{A}_{1} = {p}_{1} {N}_{2} = {q}_{1} {N}_{3} {N}_{5} + 1 , {A}_{2} = {p}_{2} {N}_{3} {N}_{5} = {q}_{2} {N}_{2} + 1 \\ {B}_{1} = {p}_{3} {N}_{3} = {q}_{3} {N}_{5} + 1 , {B}_{2} = {p}_{4} {N}_{5} = {q}_{4} {N}_{3} + 1 \\ \begin{matrix}{n}_{2} , {k}_{2} = \{ 0 , 1 , … , {N}_{2} - 1 \} ; \\ {n}_{3} , {k}_{3} = \{ 0 , 1 , … , {N}_{3} - 1 \} ; \\ {n}_{5} , {k}_{5} = \{ 0 , 1 , … , {N}_{5} - 1 \}\end{matrix}\end{matrix} \qquad ( 2 )$$

In Equation 2, p₁, p₂, p₃, p₄, q₁, q₂, Q₃, q₄ are positive integers. Accordingly, Equation 2 may be represented by the following Equation 3. This is referred to as a prime factor algorithm (PFA).

$$X ( {k}_{2} , {k}_{3} , {k}_{5} ) = {\sum }_{{n}_{5} = 0}^{{N}_{5} - 1} \{ {\sum }_{{n}_{3} = 0}^{{N}_{3} - 1} \{ {\sum }_{{n}_{2} = 0}^{{N}_{2} - 1} x ( {n}_{2} , {n}_{3} , {n}_{5} ) {W}_{{N}_{2}}^{{n}_{2} {k}_{2}} \} {W}_{{N}_{3}}^{{n}_{3} {k}_{3}} \} {W}_{{N}_{5}}^{{n}_{5} {k}_{5}} \qquad ( 3 )$$

In Equation 3, N₂ may be dissolved into radix-2 processors having eight dimensions using a linear mapping method. In this case, this resolution method is referred to as a common factor algorithm (CFA). The following Equation 4 is obtained by the CFA:

$${n}_{2} = 128 {n}_{21} + 64 {n}_{22} + 32 {n}_{23} + 16 {n}_{24} + 8 {n}_{25} + 4 {n}_{26} + 2 {n}_{27} + {n}_{28} \\ where \\ {n}_{21} , {n}_{22} , {n}_{23} , {n}_{24} , {n}_{25} , {n}_{26} , {n}_{27} , {n}_{28} = \{ 0 , 1 \} \\ {k}_{2} = {k}_{21} + 2 {k}_{22} + 4 {k}_{23} + 8 {k}_{24} + 16 {k}_{25} + 32 {k}_{26} + 64 {k}_{27} + 128 {k}_{28} \\ where \\ {k}_{21} , {k}_{22} , {k}_{23} , {k}_{24} , {k}_{25} , {k}_{26} , {k}_{27} , {k}_{28} = \{ 0 , 1 \} \\ X ( {k}_{21} + 2 {k}_{22} + 4 {k}_{23} + 8 {k}_{24} + 16 {k}_{25} + 32 {k}_{26} + 64 {k}_{27} + 128 {k}_{28} ) \\ {\sum }_{{n}_{28} = 0}^{1} \{ {\sum }_{{n}_{27} = 0}^{1} \{ {\sum }_{{n}_{26} = 0}^{1} \{ {\sum }_{{n}_{25} = 0}^{1} \{ {\sum }_{{n}_{24} = 0}^{1} \{ {\sum }_{{n}_{23} = 0}^{1} \{ {\sum }_{{n}_{22} = 0}^{1} \{ {\sum }_{{n}_{21} = 0}^{1} x ( {n}_{2} ) \cdot {W}_{2}^{{n}_{21} {k}_{21}} \} \cdot {W}_{4}^{{n}_{22} {k}_{21}} \cdot {W}_{2}^{{n}_{22} {k}_{22}} \} \cdot {W}_{8}^{{n}_{23} ( {k}_{21} + 2 {k}_{22} )} \cdot {W}_{2}^{{n}_{23} {k}_{23}} \} \cdot {W}_{16}^{{n}_{24} ( {k}_{21} + 2 {k}_{22} + 4 {k}_{23} )} \cdot {W}_{2}^{{n}_{24} {k}_{24}} \} \cdot {w}_{32}^{{n}_{25} ( {k}_{21} + 2 {k}_{22} + 4 {k}_{23} + 8 {k}_{24} )} \cdot {W}_{2}^{{n}_{25} {k}_{25}} \} \cdot {W}_{64}^{{n}_{26} ( {k}_{21} + 2 {k}_{22} + 4 {k}_{23} + 8 {k}_{24} + 16 {k}_{25} )} \cdot {W}_{2}^{{n}_{26} {k}_{26}} \} \cdot {W}_{128}^{{n}_{27} ( {k}_{21} + 2 {k}_{22} + 4 {k}_{23} + 8 {k}_{24} + 16 {k}_{25} + 32 {k}_{26} )} \cdot {W}_{2}^{{n}_{27} {k}_{27}} \} \cdot {W}_{256}^{{n}_{28} ( {k}_{21} + 2 {k}_{22} + 4 {k}_{23} + 8 {k}_{24} + 16 {k}_{25} + 32 {k}_{26} + 64 {k}_{27} )} \cdot {W}_{2}^{{n}_{28} {k}_{28}} \qquad ( 4 )$$

In the same manner, N₃ may be dissolved into radix-3 processors having five dimensions, and the following Equation 5 is obtained:

$${n}_{3} = 81 {n}_{31} + 27 {n}_{32} + 9 {n}_{33} + 3 {n}_{34} + {n}_{35} \\ where \\ {n}_{31} , {n}_{32} , {n}_{33} , {n}_{34} , {n}_{35} = \{ 0 , 1 , 2 \} \\ {k}_{3} = {k}_{31} + 3 {k}_{32} + 9 {k}_{33} + 27 {k}_{34} + 81 {k}_{35} \\ where \\ {k}_{31} , {k}_{32} , {k}_{33} , {k}_{34} , {k}_{35} = \{ 0 , 1 , 2 \} \\ X ( {k}_{31} + 3 {k}_{32} + 9 {k}_{33} + 27 {k}_{34} + 81 {k}_{35} ) = {\sum }_{{n}_{35} = 0}^{2} \{ {\sum }_{{n}_{34} = 0}^{2} \{ {\sum }_{{n}_{33} = 0}^{2} \{ {\sum }_{{n}_{32} = 0}^{2} \{ {\sum }_{{n}_{31} = 0}^{2} x ( 81 {n}_{31} + 27 {n}_{32} + 9 {n}_{33} + 3 {n}_{34} + {n}_{35} ) \cdot {W}_{3}^{{n}_{31} {k}_{31}} \} \cdot {W}_{9}^{{n}_{32} {k}_{31}} \cdot {W}_{3}^{{n}_{32} {k}_{32}} \} \cdot {W}_{27}^{{n}_{33} ( {k}_{31} + 3 {k}_{32} )} \cdot {W}_{3}^{{n}_{33} {k}_{33}} \} \cdot {W}_{81}^{{n}_{34} ( {k}_{31} + 3 {k}_{32} + 9 {k}_{33} )} \cdot {W}_{3}^{{n}_{34} {k}_{34}} \} \cdot {W}_{243}^{{n}_{35} ( {k}_{31} + 3 {k}_{32} + 9 {k}_{33} + 27 {k}_{34} )} \cdot {W}_{3}^{{m}_{35} {k}_{35}} \qquad ( 5 )$$

In the same manner, N5 may be dissolved into radix-5 processors having three dimensions, and the following Equation 6 is obtained:

$${n}_{5} = 5 {n}_{51} + {n}_{52} \\ where \\ {n}_{51} , {n}_{52} = \{ 0 , 1 , 2 , 3 , 4 \} \\ {k}_{5} = {k}_{51} + 5 {k}_{52} \\ where \\ {k}_{51} , {k}_{52} = \{ 0 , 1 , 2 , 3 , 4 \} \\ X ( {k}_{51} + 5 {k}_{52} ) = {\sum }_{{n}_{52} = 0}^{4} \{ {\sum }_{{n}_{51} = 0}^{4} x ( 5 {n}_{51} + {n}_{52} ) \cdot {W}_{5}^{{n}_{51} {k}_{51}} \} \cdot {W}_{25}^{{n}_{52} {k}_{51}} \cdot {W}_{5}^{{n}_{52} {k}_{52}} \qquad ( 6 )$$

Equations 4, 5 and 6 may correspond to radix chains that correspond to radix-2, radix-3 and radix-5, respectively. In this case, the three radix chains may be finally represented as a single structure via a PFA based on Equation 3. An algorithm in which an PFA and a CFA have been combined with each other and which is derived using Equations 1 to 6 requires an index mapping operation that finally changes sequence order at input and output terminals, which may be performed using Equation 2.

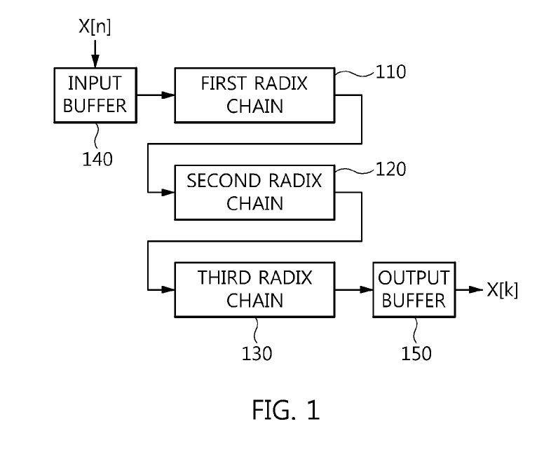

FIG. 1 is a block diagram of a mixed-radix pipelined FFT processor according to an embodiment of the present invention.

Referring to FIG. 1, the mixed-radix pipelined FFT processor according to this embodiment of the present invention includes a first radix chain 110, a second radix chain 120, a third radix chain 130, an input buffer 140, and an output buffer 150.

In this case, the input buffer 140 and the output buffer 150 are provided to perform index mapping based on a PFA.

The first radix chain 110 includes first radix processors that are connected in series to each other.

The second radix chain 120 includes second radix processors that are connected in series to each other, and is connected in series to the first radix chain.

The third radix chain 130 includes third radix processors that are connected in series to each other, and is connected in series to the second radix chain.

In this case, the first radix chain 110, the second radix chain 120, and the third radix chain 130 may correspond to a radix-2⁸ chain, a radix-3⁵ chain, and a radix 5² chain, respectively.

The input buffer 140 performs index mapping on a sequence that is input to the first radix chain 110.

The output buffer 150 generates a final FFT output by performing index mapping on a sequence that is generated using the outputs of any one or more of the first, second and third radix chains 110, 120 and 130.

In this case, the first, second and third radices may be all prime numbers.

In this case, according to the PFA, the first, second and third radix chains 110, 120 and 130 may be connected in series without twiddle factor multiplications.

The first radix chain 110 may include first buffers configured to correspond to the first radix processors, respectively, first trivial multipliers configured to perform twiddle factor multiplications between the first radix processors, and a first multiplexer configured to multiplex the outputs of one or more of the first radix processors.

The second radix chain 120 may include second buffers configured to correspond to the second radix processors, respectively, trivial multipliers configured to perform twiddle factor multiplications between the second radix processors, and a second multiplexer configured to multiplex the outputs of the one or more of the second radix processors.

The third radix chain 130 may include third buffers configured to correspond to the third radix processors, respectively, one or more third trivial multipliers configured to perform twiddle factor multiplications between the third radix processors, and a third multiplexer configured to multiplex the outputs of one or more of the third radix processors.

In this case, the first radix chain 110, the second radix chain 120 and the third radix chain 130 may support various FFT lengths by controlling latencies corresponding to the first buffers, the second buffers and the third buffers.

The first radix chain 110, the second radix chain 120 and the third radix chain 130 include radix-2, radix-3 and radix-5 processors according to a CFA. In this case, the radix-3 and radix-5 processors may be implemented using Winograd FFTs. Inside the first radix chain 110, second radix chain 120 and third radix chain 130, the radix-r processors may be connected in series through twiddle factor multiplications. The first radix chain 110, the second radix chain 120 and the third radix chain 130 may each include therein a multiplexer that functions to multiplex outputs and transfer results to a subsequent chain.

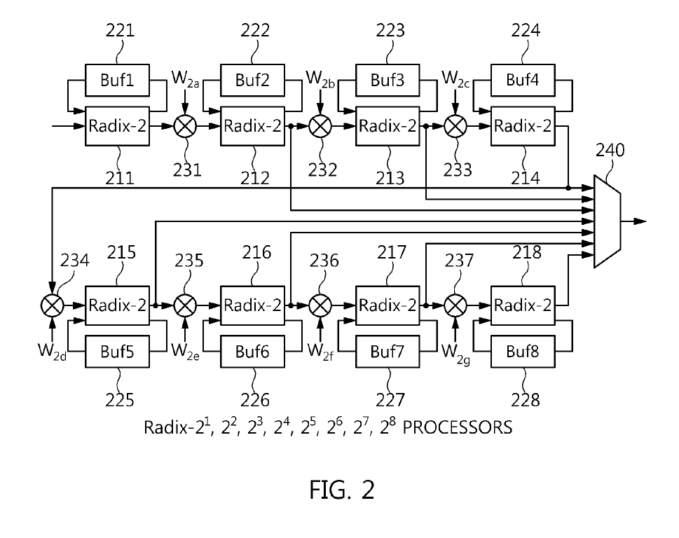

FIG. 2 is a block diagram illustrating an example of the first radix chain illustrated in FIG. 1.

Referring to FIG. 2, the first radix chain illustrated in FIG. 1 includes radix-2 processors 211, 212, 213, 214, 215, 216, 217 and 218, buffers 221, 222, 223, 224, 225, 226, 227 and 228, trivial multipliers 231, 232, 233, 234, 235, 236 and 237, and a multiplexer 240.

The radix-2 processors illustrated in FIG. 2 correspond to the first radix processors that are set forth in the attached claims.

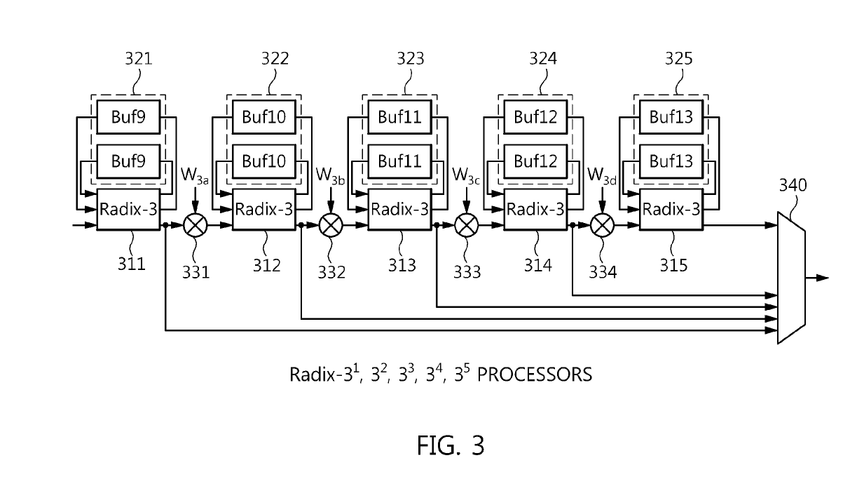

FIG. 3 is a block diagram illustrating an example of the second radix chain illustrated in FIG. 1.

Referring to FIG. 3, the second radix chain illustrated in FIG. 1 includes radix-3 processors 311, 312, 313, 314 and 315, buffers 321, 322, 323, 324 and 325, trivial multipliers 331, 332, 333 and 334, and a multiplexer 340.

The radix-3 processors illustrated in FIG. 3 correspond to the second radix processors that are set forth in the attached claims.

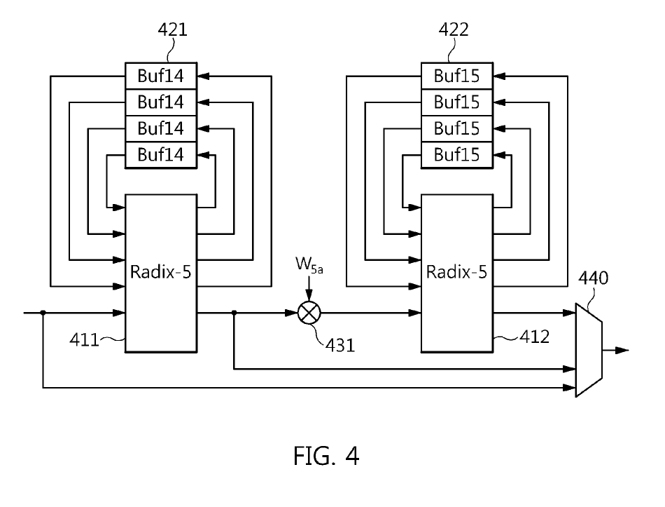

FIG. 4 is a block diagram illustrating an example of the third radix chain illustrated in FIG. 1.

Referring to FIG. 4, the third radix chain illustrated in FIG. 1 includes radix-5 processors 411 and 412, buffers 421 and 422, a trivial multiplier 431, and a multiplexer 440.

The radix-5 processors illustrated in FIG. 4 correspond to the third radix processors that are set forth in the attached claims.

The twiddle index values shown in FIGS. 2 to 4 may be used to control trivial factors or derive addresses when twiddle multiplications are performed in each radix chain, and may be defined as follows. In this case, the twiddle index values may be simply generated by means of counters using prime numbers 2, 3, and 5 as bases.

W₂ₐ=W₄[n₂₂k₂₁]

W_{2b}=W₈[n₂₃(k₂₁+2k₂₂)]

W_{2c}=W₁₆[n₂₄(k₂₁+2k₂₂+4k₂₃)]

W_{2d}=W₃₂[n₂₅(k₂₁+2k₂₂+4k₂₃+8k₂₄)]

W₂ₑ=W₆₄[n₂₆(k₂₁+2k₂₂+4k₂₃+8k₂₄+16k₂₅)]

W_{2f}=W₁₂₈[n₂₇(k₂₁+2k₂₂+4k₂₃+8k₂₄+16k₂₅+32k₂₆)]

W_{2g}=W₁₂₈[n₂₈(k₂₁+2k₂₂+4k₂₃+8k₂₄+16k₂₅+32k₂₆+64k₂₇)]

W₃ₐ=W₉[n₃₂k₃₁]

W_{3b}=W₂₇[n₃₃(k₃₁+3k₃₂)]

W_{3c}=W₈₁[n₃₄(k₃₁+3k₃₂+9k₃₃)]

W_{3d}=W₂₄₃[n₃₅(k₃₁+3k₃₂+9k₃₃+27k₃₄)]

W₅ₐ=W₂₅[n₅₂k₅₁]

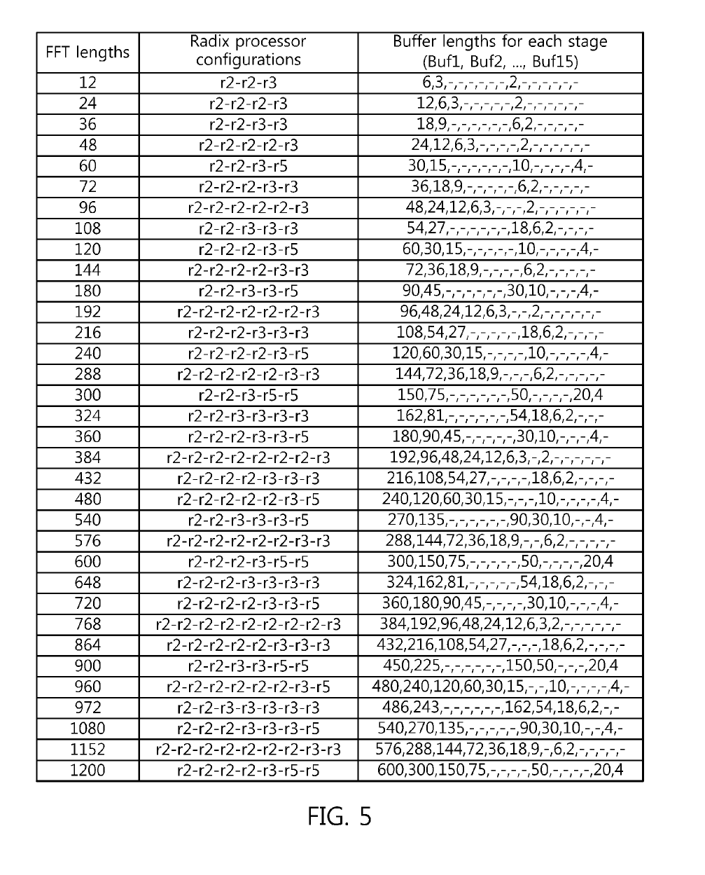

FIG. 5 is a diagram illustrating the radix and buffer configurations of 34 FFTs.

In FIG. 5, the symbol “−” indicates that the buffer is not used.

The conventional in-place scheme and the pipelining scheme of the present invention are compared, as follows. With regard to the mixed-radix FFT that supports 34 lengths presented by the LTE uplink standard, the comparison may be carried out in two aspects.

First, in the case of the pipelining scheme according to the present invention, the latency has N−1 delays between input and output. Accordingly, a 1200-point DFT having the highest latency has a latency of 1199 cycles. In the case of the conventional in-place scheme, the latency may be represented by the total sum of the numbers of radix-r operations that are processed in respective stages. Accordingly, in this case, a 1152-point DFT has the highest latency of 4800 cycles (the internal delay applied to the inside of the radix-r processor is not taken into account). When the in-place scheme is implemented using radix-2, 3, 4 and 5, the 1152-point DFT has a delay of 2208 cycles.

Second, memory should be organized into banks according to the radix-r because the amount of use of buffers can satisfy simultaneous input and output processing conditions in the case of the in-place scheme. Furthermore, since 34 DFTs should be processed, the chain configurations of radix-2, radix-3 and radix-5 should be changed, so that five banks should be supported and the size of each of the banks is determined depending on a maximum DFT length that should be supported. Accordingly, the memory sizes of five banks are 600, 600, 400, 240, and 240, respectively. As a result, in the case of the in-place scheme, the total amount of use of buffers is 2080. When the in-place scheme is implemented using radix-2, 3, 4 and 5, banks have memory sizes of 600, 600, 400, 300 and 240, and thus the total amount of use of buffers is 2140.

In the case of the pipelining scheme according to the present invention, the total amount of use of buffers, including Buf1 to Buf15 illustrated in FIGS. 2 to FIG. 4, is 1457. As a result, it can be seen that the pipelining scheme is advantageous in terms of the total amount of use of buffers.

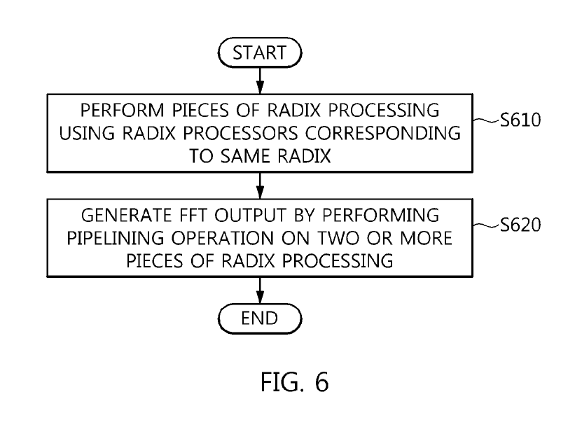

FIG. 6 is a flowchart illustrating an FFT processing method according to an embodiment of the present invention.

Referring to FIG. 6, in the FFT processing method according to this embodiment of the present invention, radix processing using radix processors corresponding to the same radix is performed at step S610.

In this case, the radix processors are connected in series to each other, and the radix may be a prime number.

In this case, step S610 may include the step of performing twiddle factor multiplications between the radix processors using the trivial multipliers.

Furthermore, in the FFT processing method according to this embodiment of the present invention, FFT output is generated via a pipelining operation with respect to two or more pieces of radix processing at step S620.

In this case, a pipelining operation may be performed without twiddle factor multiplications.

The individual steps illustrated in FIG. 6 may be performed in the order illustrated in FIG. 6, in the reverse order thereof, or at the same time.

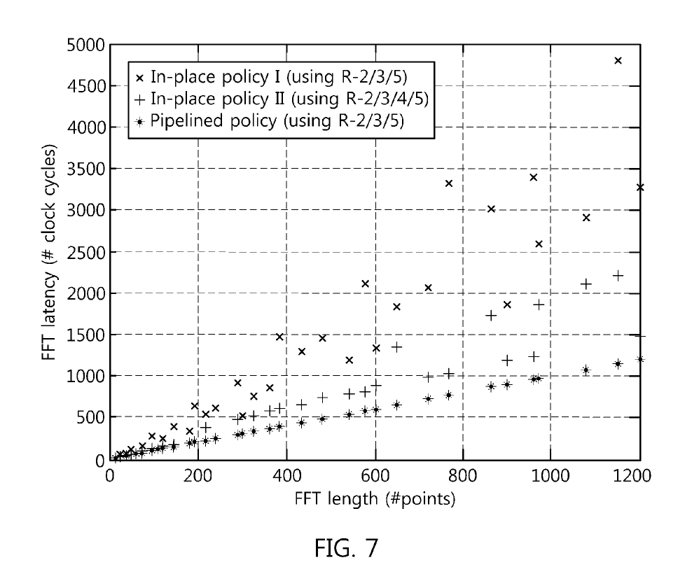

FIG. 7 is a diagram illustrating the FFT latencies of the single memory-based FFT processor and the FFT processor of the present invention with respect to FFT lengths.

Referring to FIG. 7, it can be seen that the pipelining scheme according to the present invention is considerably more advantageous in terms of the use of memory and processing time than the in-place scheme. The pipelining scheme according to the present invention can reduce hardware cost using simplified twiddle multipliers, and can easily perform multiplexer control using digit counters. Accordingly, the pipelining scheme according to the present invention may be efficiently used in the fields of application that require high-speed DFT processing, such as an LTE base stage.

That is, the pipelining scheme according to the present invention can considerably reduce hardware cost by minimizing or eliminating the use of complex multipliers that occupy a large portion of hardware in the design of an FFT, and can considerably reduce the size of hardware by optimizing the use of memory buffers. In particular, the pipelining scheme according to the present invention may be widely used in the field of signal processing application that requires an FFT processor having lengths based on a prime number, such as 2, 3, 5 or 7. In particular, the present invention may operate in a pipelining manner, and thus is highly useful for the field of application that requires high data throughput.

As described above, the present invention provides the pipelined FFT processor that can be efficiently applied to the processing of various prime length FFTs, that is efficient in terms of a circuit area, and that has high throughput.

Furthermore, the present invention provides the FFT processor that includes radix-r chains corresponding to different prime numbers, and that is configured such that each of the radix-r chains operates in a pipelining manner, thereby providing high throughput and low latency while reducing the hardware complexity of the FFT processor.

Moreover, the present invention provides the pipelined FFT processor that includes radix-r chains corresponding to different prime numbers, that does not require twiddle factor ROM because twiddle factor multiplications do not need to be performed between the chains, that does not require variable complex multiplications, and that can process 34 FFT lengths required by the LTE standard using only trivial multipliers.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A mixed-radix pipelined Fast Fourier Transform (FFT) processor, comprising:
a first radix chain configured to include first radix processors that are connected in series to each other;
a second radix chain configured to include second radix processors that are connected in series to each other, and to be connected in series to the first radix chain;
an input buffer configured to perform index mapping on a sequence input to the first radix chain; and
an output buffer configured to generate a final FFT output by performing index mapping on a sequence generated using outputs of one or more of the first and second radix chains.

2. The mixed-radix pipelined FFT processor of claim 1, wherein first and second radices of the first and second radix chains are all prime numbers.

3. The mixed-radix pipelined FFT processor of claim 2, wherein the first and second radix chains are directly connected to each other without twiddle factor multiplications.

4. The mixed-radix pipelined FFT processor of claim 3, wherein the first radix chain comprises first buffers configured to correspond to the first radix processors, first trivial multipliers configured to perform twiddle factor multiplications between the first radix processors, and a first multiplexer configured to multiplex outputs of one or more of the first radix processors.

5. The mixed-radix pipelined FFT processor of claim 4, wherein the second radix chain comprises second buffers configured to correspond to the second radix processors, second trivial multipliers configured to perform twiddle factor multiplications between the second radix processors, and a second multiplexer configured to multiplex outputs of one or more of the second radix processors.

6. The mixed-radix pipelined FFT processor of claim 5, wherein:
the mixed-radix pipelined FFT processor further comprises a third radix chain that comprises third radix processors connected in series to each other and that is connected in series to the second radix chain;
a third radix of the third radix change is a prime number;
the output buffer generates the final FFT output by performing index mapping on a sequence generated using outputs of one or more of the first, second and third radix chains; and
the third radix chain is connected in series to the second radix chain without twiddle factor multiplications.

7. The mixed-radix pipelined FFT processor of claim 6, wherein the third radix chain comprises third buffers configured to correspond to the third radix processors, one or more third trivial multipliers configured to perform twiddle factor multiplications between the third radix processors, and a third multiplexer configured to multiplex outputs of one or more of the third radix processors.

8. The mixed-radix pipelined FFT processor of claim 7, wherein the first, second and third radix chains support various FFT lengths by controlling respective latencies corresponding to the first, second and third buffers.

9. An FFT processing method, comprising:
performing pieces of radix processing using radix processors corresponding to a same radix; and
generating an FFT output by performing a pipelining operation on two or more pieces of radix processing.

10. The FFT processing method of claim 9, wherein the radix processors are connected in series to each other, and the radix is a prime number.

11. The FFT processing method of claim 10, wherein performing the radix processing comprises performing twiddle factor multiplications between the radix processors using trivial multipliers.

12. The FFT processing method of claim 11, wherein the pipelining operation is performed without twiddle factor multiplications.
